(19) United States
(12) Patent Application Publication
(10) Pub. No.: US 2003/0005042 A1
(43) Pub. Date: Jan. 2, 2003

(54) Method and system for detecting aborted connections and modified documents from web server logs

(76) Inventors: Magnus Karlsson, Mountain View, CA (US); Ludmila Cherkasova, Sunnyvale, CA (US)

Correspondence Address: HEWLETT-PACKARD COMPANY, Intellectual Property Administration, P.O. Box 272400, Fort Collins, CO, 80527-2400, US

(21) Appl. No.: 09/898,196

(22) Filed: Jul. 2, 2001

(51) Int. Cl. G06F 15/16

(52) U.S. Cl. 709/203

(57) ABSTRACT

One embodiment of the present invention provides a method for detecting client aborted connections from web access logs produced by web servers. The present embodiment utilizes the following two fields of the logs: the requested web document name and the number of bytes transferred by the web server of that requested document. Specifically, the present embodiment first determines the real size of the web document from the log information. Once determined, if another transferred bytes value is less than the real size, the document was either modified or the client aborted the connection. The present embodiment filters out the document modifications from the aborted connections by relying on the assumption that modifications to a document generate one change in transferred bytes followed by the same size for a time while an aborted connection will manifest itself as a one time change in the number of transferred bytes.

### TECHNICAL FIELD

The present invention relates to the field of computers. More specifically, the present invention relates to the field of web servers and detecting aborted connections and/or modified documents.

### BACKGROUND ART

Computers and other electronic devices have become integral tools used in a wide variety of different applications, such as in finance and commercial transactions, computer-aided design and manufacturing, health care, telecommunication, education, etc. Computers along with other electronic devices are finding new applications as a result of advances in hardware technology and rapid development in software technology. Furthermore, the functionality of a computer system or other type of electronic device is dramatically enhanced by coupling these type of stand-alone devices together in order to form a networking environment. Within a networking environment, users may readily exchange files, share information stored on a common database, pool resources, and communicate via electronic mail (e-mail) and video teleconferencing. Furthermore, computers along with other types of electronic devices which are coupled to the Internet provide their users access to data and information from all over the world. Computer systems have become useful in many aspects of everyday life both for personal and business uses.

It is appreciated that a computer (e.g., desktop or laptop) may be communicatively coupled to the Internet or other computers via wired or wireless technologies. For example, a telephone line may be attached to a serial communication (COM) port of a computer thereby enabling the computer to communicate with the Internet via wired technology. Furthermore, a Global System for Messaging (GSM) digital cellular phone may also be attached to a serial COM port of a computer thereby enabling the computer to wirelessly communicate with the Internet. Therefore, once the computer is communicatively coupled to the Internet using wired and/or wireless technologies, its user(s) may access web sites all over the world which provide a wide variety of information.

However, there are disadvantages associated with some of the web sites of the Internet. For example, some web sites are unable to handle in a timely manner all of the web page requests that they receive from client computers. This lack of performance may be caused by the fact that the web sites may not have enough processing power thereby prolonging their response times. Given the prolonged response time of some web sites, computer users get impatient waiting for web content to completely download to their computers and they eventually hit the “Stop” button of their Internet browser thereby aborting the connection with the web site server. Therefore, one way to measure the quality of service of a web site server from a performance point of view is to determine its amount of aborted connections during a given period of time.

There are difficulties associated with determining the amount of web server connections that were aborted by client computers. For example, one of the difficulties is that today's web servers currently do not keep track of aborted connections. However, in the past (and some may still be operating today) web servers detected their aborted connections at the operating system level and subsequently kept track of them. Some of the disadvantages with this approach is that it is not currently supported on all web servers (e.g., Apache, Netscape Lite, and others) and it also degrades the performance of its web servers.

One solution to enable today's web servers to keep track of aborted connections is to modify their web server application code. However, a disadvantage associated with this solution is that it involves a time consuming process that can be very costly to perform. Another disadvantage associated with this solution is that the extra logging of aborted connections degrades the performance of the web server. A further disadvantage associated with this solution is that a person has to have access to the web server application code otherwise he or she is not able to modify it in the first place.

### SUMMARY OF THE INVENTION

Accordingly, a need exists for a method and system for detecting aborted connections of a web server that does not involve modify web server application code. Furthermore, a need exists for a method and system that accomplishes the above need and is not burdensome to implement, does not adversely affect web server performance, and is cost efficient. The present invention provides a method and system which accomplishes the above mentioned needs.

For instance, one embodiment of the present invention provides a method for detecting client aborted connections from web access logs produced by web servers. The present embodiment utilizes the following two fields of the logs: the requested web document name and the number of bytes transferred by the web server of that requested document. Specifically, the present embodiment first determines the real size of the web document from the log information. Once determined, if another transferred bytes value is less than the real size, the document was either modified or the client aborted the connection. The present embodiment filters out the document modifications from the aborted connections by relying on the assumption that modifications to a document generate one change in transferred bytes followed by the same size for a time while an aborted connection will manifest itself as a one time change in the number of transferred bytes.

In another embodiment, the present invention includes a method for detecting an aborted connection from a log of a server. The method include the step of finding a file within the log that is static. Furthermore, the method includes the step of detecting the aborted connection utilizing the size of the file and a first data value of a plurality of data values of the log of the server. It should be understood that the plurality of data values correspond to data transferred by the server in response to requests for the file.

In yet another embodiment, the present invention includes a computer readable medium having computer readable code embodied therein for causing a computer to perform particular steps. Specifically, the computer readable medium causes the computer to perform the steps described within the previous paragraph.

These and other advantages of the present invention will no doubt become obvious to those of ordinary skill in the art after having read the following detailed description of the preferred embodiments which are illustrated in the drawing figures.

### BRIEF DESCRIPTION OF THE DRAWINGS

The accompanying drawings, which are incorporated in and form a part of this specification, illustrate embodiments of the invention and, together with the description, serve to explain the principles of the invention.

FIG. 1 is a block diagram of an exemplary computer system used in accordance with an embodiment of the present invention.

FIG. 2 is a block diagram of an exemplary network used in accordance with an embodiment of the present invention.

FIGS. 3A and 3B are a flowchart of steps performed in accordance with one embodiment of the present invention for detecting aborted connections and modified documents within a web access log produced by a web server.

FIG. 4 is a simplified exemplary web access log produced by a web server that may be utilized by an embodiment of the present invention to detect aborted connections and modified documents.

FIGS. 5A and 5B are a flowchart of steps performed in accordance with one embodiment of the present invention for detecting modified documents within a web access log produced by a web server.

FIGS. 6A and 6B are a flowchart of steps performed in accordance with one embodiment of the present invention for detecting aborted connections within a web access log produced by a web server.

FIG. 7 is a flowchart of steps performed in accordance with another embodiment of the present invention for detecting aborted connections and modified documents within a web access log produced by a web server.

FIG. 8 is a graph illustrating the number of aborted connections and requests per day that the ESN-Europe web site experienced over an established time period.

FIG. 9 is a graph illustrating the number of aborted connections and requests per day that the Hewlett Packard (HP) Labs web site experienced over an established time period.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

Some portions of the detailed descriptions which follow are presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic signals capable of being stored, transferred, combined, compared, and otherwise manipulated in a computer system or similar electronic computing device. For reasons of convenience, and with reference to common usage, these signals are referred to as bits, values, elements, symbols, characters, terms, numbers, or the like with reference to the present invention.

It should be borne in mind, however, that all of these terms are to be interpreted as referencing physical manipulations and quantities and are merely convenient labels and are to be interpreted further in view of terms commonly used in the art. Unless specifically stated otherwise as apparent from the following discussions, it is understood that throughout discussions of the present invention, discussions utilizing terms such as “finding” or “determining” or “detecting” or “outputting” or “transmitting” or “locating” or “storing” or “receiving” or “recognizing” or “utilizing” or “generating” or “providing” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers or other such information storage, transmission, or display devices.

### Exemplary Hardware in Accordance with the Present Invention

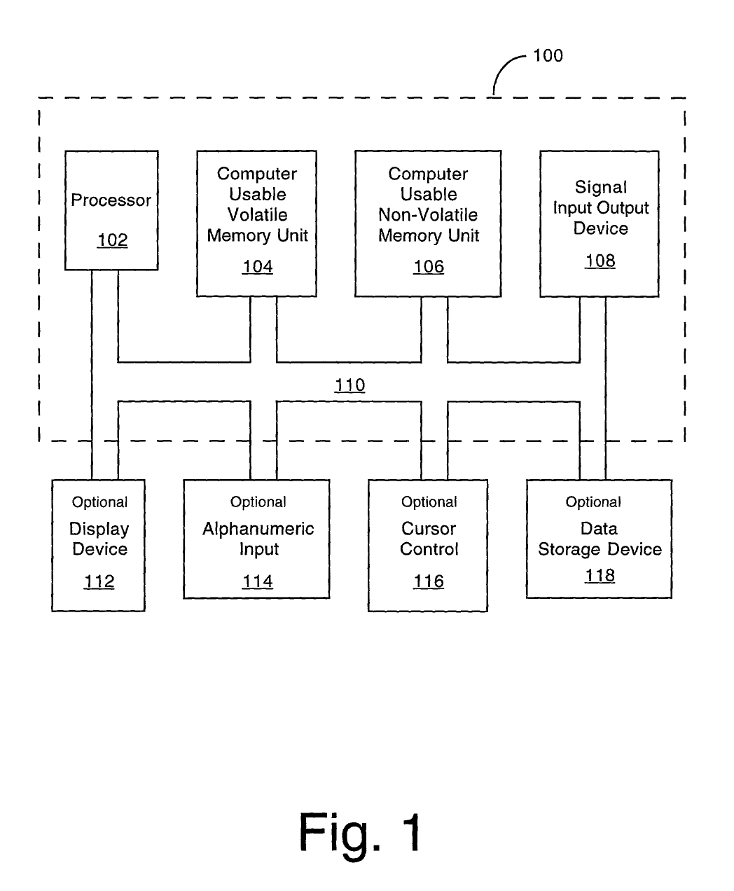

FIG. 1 is a block diagram of one embodiment of an exemplary computer system 100 used in accordance with the present invention. It should be appreciated that system 100 is not strictly limited to be a computer system. As such, system 100 of the present embodiment is well suited to be any type of computing device (e.g., server computer, portable computing device, desktop computer, etc.). Within the following discussions of the present invention, certain processes and steps are discussed that are realized, in one embodiment, as a series of instructions (e.g., software program) that reside within computer readable memory units of computer system 100 and executed by a processor(s) of system 100. When executed, the instructions cause computer 100 to perform specific actions and exhibit specific behavior which is described in detail below.

Computer system 100 of FIG. 1 comprises an address/data bus 110 for communicating information, one or more central processors 102 coupled with bus 110 for processing information and instructions. Central processor unit 102 may be a microprocessor or any other type of processor. The computer 100 also includes data storage features such as a computer usable volatile memory unit 104 (e.g., random access memory, static RAM, dynamic RAM, etc.) coupled with bus 110 for storing information and instructions for central processor(s) 102, a computer usable non-volatile memory unit 106 (e.g., read only memory, programmable ROM, flash memory, EPROM, EEPROM, etc.) coupled with bus 110 for storing static information and instructions for processor(s) 102. System 100 also includes one or more signal generating and receiving devices 108 coupled with bus 110 for enabling system 100 to interface with other electronic devices and computer systems. The communication interface(s) 108 of the present embodiment may include wired and/or wireless communication technology. For example, within the present embodiment, the communication interface 108 is a serial communication port, but could also alternatively be any of a number of well known communication standards and protocols, e.g., Universal Serial Bus (USB), Ethernet, FireWire (IEEE 1394), parallel, small computer system interface (SCSI), infrared (IR) communication, Bluetooth wireless communication, broadband, and the like.

Optionally, computer system 100 can include an alphanumeric input device 114 including alphanumeric and function keys coupled to the bus 110 for communicating information and command selections to the central processor(s) 102. The computer 100 can include an optional cursor control or cursor directing device 116 coupled to the bus 110 for communicating user input information and command selections to the central processor(s) 102. The cursor directing device 116 can be implemented using a number of well known devices such as a mouse, a track-ball, a track-pad, an optical tracking device, a touch screen, etc. Alternatively, it is appreciated that a cursor can be directed and/or activated via input from the alphanumeric input device 114 using special keys and key sequence commands. The present embodiment is also well suited to directing a cursor by other means such as, for example, voice commands. The system 100 can also include a computer usable mass data storage device 118 such as a magnetic or optical disk and disk drive (e.g., hard drive or floppy diskette) coupled with bus 110 for storing information and instructions. An optional display device 112 is coupled to bus 110 of system 100 for displaying video and/or graphics. It should be appreciated that optional display device 112 may be a cathode ray tube (CRT), flat panel liquid crystal display (LCD), field emission display (FED), or any other display device suitable for displaying video and/or graphic images and alphanumeric characters recognizable to a user.

### Exemplary Network in Accordance with the Present Invention

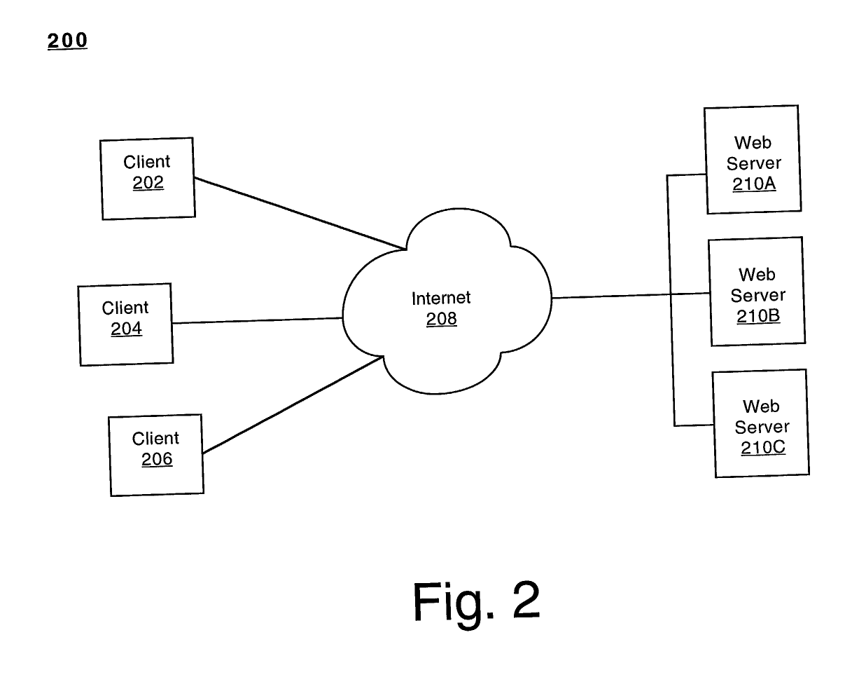

FIG. 2 is a block diagram of an exemplary network 200 used in accordance with an embodiment of the present invention. For example, network 200 includes client devices 202-206 that are requesting web documents from one or more web servers 210A-210C which belong to the same web site. Each of the web servers 210A-210C produces a web access log that contains all of the requests it receives from the clients (e.g., 202-206). As such, an embodiment of the present invention utilizes these web access logs in order to measure the performance of the web servers (e.g., 210A-210C). Specifically, an embodiment of the present invention utilizes web access logs to measure the amount of aborted connections that the web servers encounter.

Network 200 includes web servers 210A, 210B and 210C which are communicatively coupled to the Internet 208. Additionally, client devices 202, 204 and 206 are communicatively coupled to the Internet 208. It should be appreciated that the devices of network 200 of the present embodiment are well suited to be coupled in a wide variety of implementations. For example, web servers 210A, 210B and 210C and client devices 202, 204 and 206 of network 200 may be coupled via coaxial cable, copper wire, fiber optics, the Internet 208, wireless communication, and the like.

Within network 200 of FIG. 2, it is understood that client devices 202-206 may each be implemented in a manner similar to computer system 100 of FIG. 1. Moreover, servers 210A-210C may be implemented in a variety ways in accordance with the present embodiment. For example, servers 210A-210C of network 200 may be implemented in a manner similar to computer system 100 of FIG. 1. However, the servers 210A-210C of network 200 are not strictly limited to such an implementation. It should be understood that network 200 is well suited to have any number of client devices (e.g., 202-206) along with any number of web servers (e.g., 210A-210C) belonging to the same web site.

### Exemplary Operations in Accordance with the Present Invention

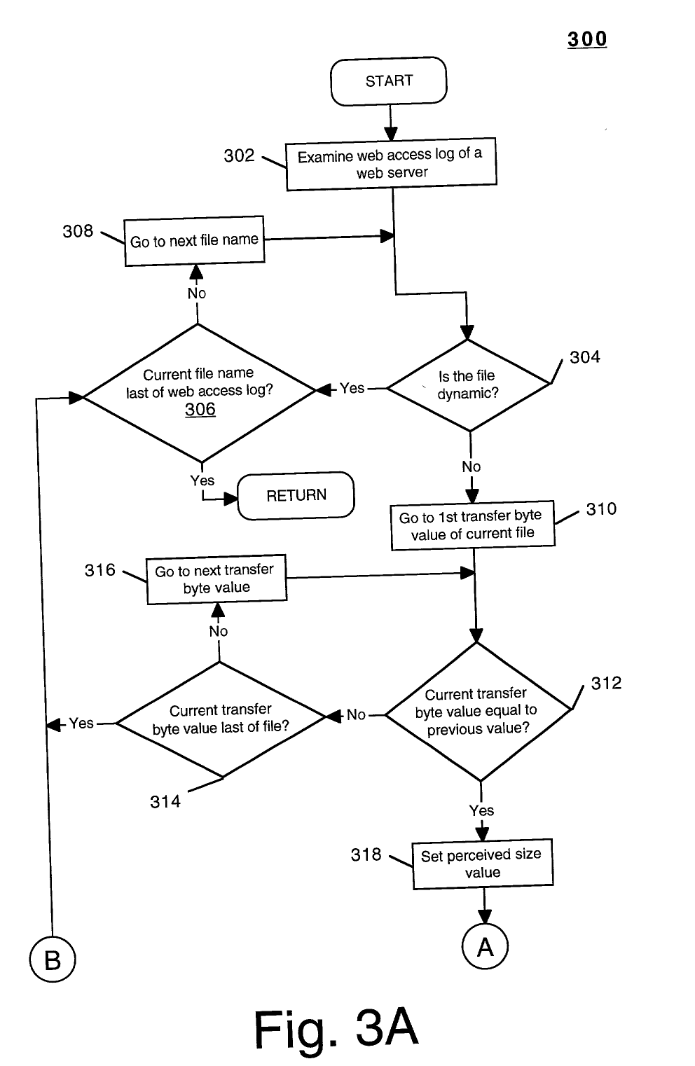

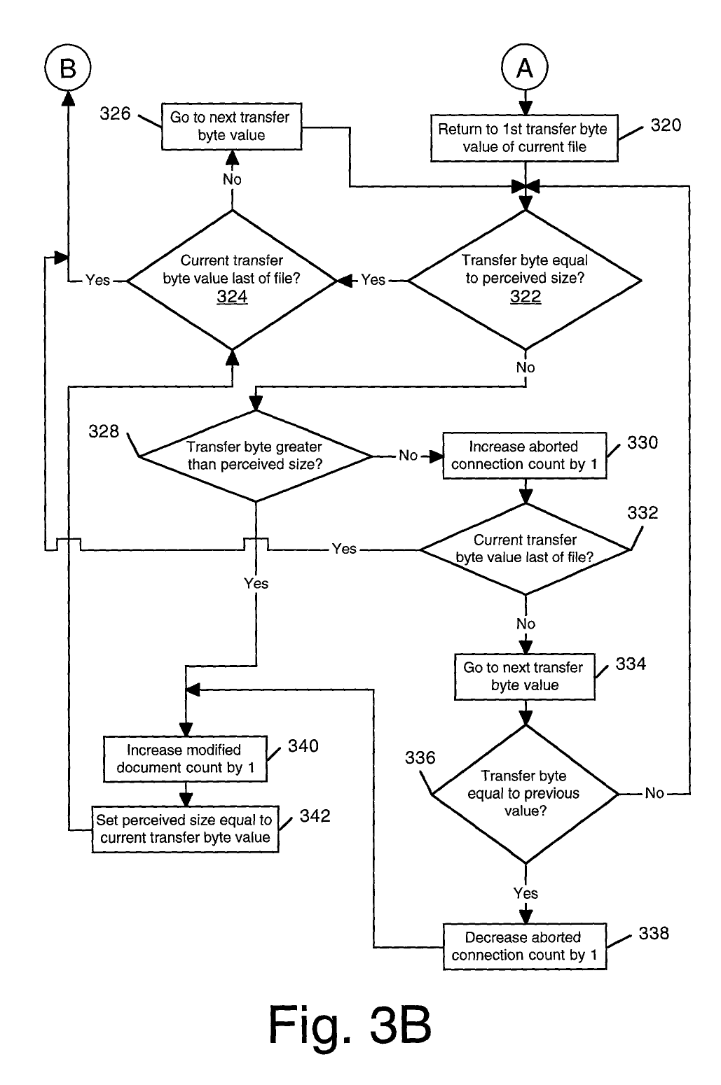

FIGS. 3A and 3B are a flowchart 300 of steps performed in accordance with one embodiment of the present invention for detecting aborted connections and modified documents from web access logs produced by a web server. Flowchart 300 includes processes of the present invention which, in one embodiment, are carried out by processors and electrical components under the control of computer readable and computer executable instructions. The computer readable and computer executable instructions reside, for example, in data storage features such as computer usable volatile memory 104 and/or computer usable non-volatile memory 106 of FIG. 1. However, the computer readable and computer executable instructions may reside in any type of computer readable medium. Although specific steps are disclosed in flowchart 300, such steps are exemplary. That is, the present invention is well suited to performing various other steps or variations of the steps recited in FIGS. 3A and 3B. Within the present embodiment, it should be appreciated that the steps of flowchart 300 may be performed by software or hardware or any combination of software and hardware.

It should be appreciated that documents are stored in the form of files in a computer system. As such, the words “document” and “file” may be used interchangeably within the detailed description of embodiments of the present invention.

One of the motivations behind flowchart 300 is to provide a method to web service providers targeted at detecting potential performance bottlenecks on web sites. One way to measure the quality of service of a web server (e.g., 210A, 210B or 210C) from a performance point of view is to measure its amount of aborted connections. The logic behind this being that if the web site is not fast enough, a client user will get impatient and hit the stop button of its browser, thus aborting the connection. Specifically, flowchart 300 is a method for detecting client aborted connections and modified web documents from the web access logs produced by web servers. The present embodiment utilizes the following two fields of web access logs: the requested web document name and the number of bytes transferred by the web server of that requested document. The present embodiment first determines the real size of the web document from the log information. Once determined, if another transferred bytes value within the log is less than the real size, the document was either modified or the client aborted the connection. The present embodiment distinguishes modified documents from the aborted connections within the web access log by relying on the assumption that modifications to a document generate one change in transferred bytes followed by the same size for a time while an aborted connection will manifest itself as a one time change in the number of transferred bytes.

At step 302 of FIG. 3A, the present embodiment examines a web access log produced by a web server (e.g., 210A, 210B, or 210C). It should be appreciated that the web access log of the present embodiment may be implemented in a wide variety of ways in accordance with the present invention. For example, a web access log of the present embodiment may be generated within a network (e.g., 200) where a number of clients devices (e.g., 202-206) are requesting web documents from one or more web servers (e.g., 210A-210C) which belong to the same web site. Each of the web servers may produce a web access log that is in the Common Access Log Format depicted below:

hostname - - [dd/mm/yyyy:hh:mm:ss tz] request status bytes

where “dd/mm/yyyy:hh:mm:ss tz” corresponds to the numerical representation of the date and time (with time zone) that a web server (e.g., 210A, 210B or 210C) responded to a web file request from a client device (e.g., 202, 204 or 206). Specifically, the “dd/mm/yyyy” corresponds to the numerical representation of the date with the day (dd), month (mm), and year (yyyy) and the “hh:mm:ss” corresponds to the numerical representation of the time with the hours (hh), minutes (mm), and seconds (ss) together with the time zone (tz). It should be appreciated that a log entry such as the one shown above may be entered by a web server (e.g., 210A, 210B or 210C) into its web access log each time it responds to a web file request from any client device (e.g., 202, 204 or 206).

Furthermore, a web access log of the present embodiment may contain all of the requests that were received by a web server (e.g., 210A, 210B or 210C) from any client devices (e.g., 202-206) including the ones that were faulty or incurred some error on the server side. The requests labeled as “successful” in delivering a document within the web access log are the ones with the requested field set to GET and the status field set to 200. However, all of the GET-200s within a web access log are not successful in the real sense of the word. For example, if a client (e.g., 202, 204 or 206) aborts a connection, the web server (e.g., 210A, 210B or 210C) is still going to report this as a GET-200 since the server successfully delivered whatever portion of the web document before the client closed (aborted) the connection. In this case, the server is going to set the bytes field to the number of bytes it transferred before the connection was aborted. Moreover, the web access log of the present embodiment may contain one entry per client requested web document. Each entry may have a variety of fields about the client request, however, the fields that the present embodiment is mainly concerned with are the name of the requested web document and the number of bytes transferred by the web server in response to that request.

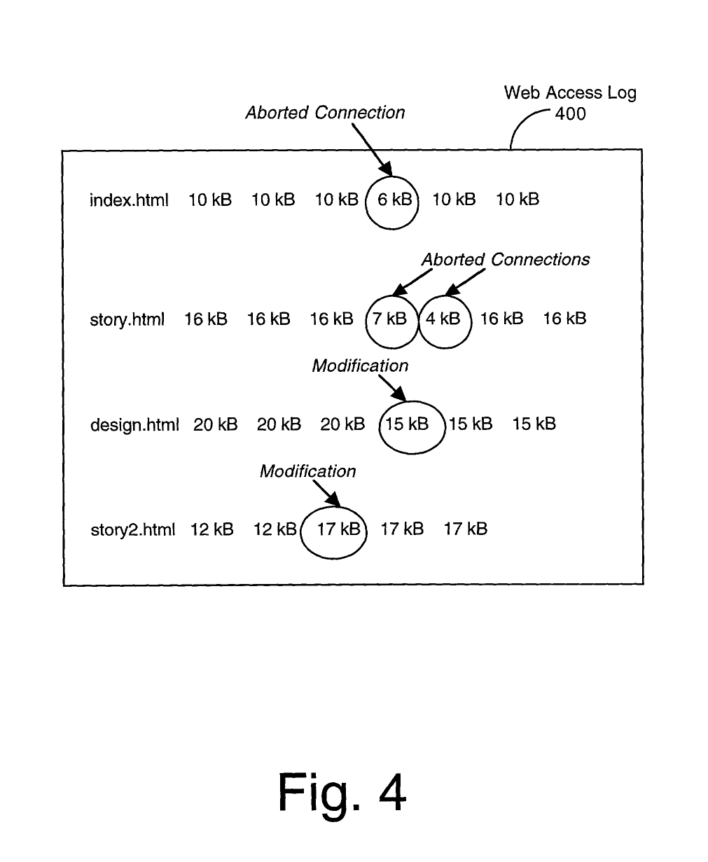

FIG. 4 is a simplified exemplary web access log 400 produced by a web server (e.g., 210A, 210B, or 210C) that may be utilized by the present embodiment to detect aborted connections and modified documents. Exemplary web access log 400 includes four different file names (e.g., “index.html”, “story.html”, “design.html”, and “story2.html”) along with the number of bytes transferred by the web server in response to each request received by the web server. Specifically, the transferred byte number adjacent to the file name was transferred first by the web server while the right most transferred byte number was transferred last. It is appreciated that the different file names of web access log 400 may be associated with files containing web content. It should be understood that the web access log 400 will be described in conjunction with flowchart 300.

In step 304 of FIG. 3A, the present embodiment determines whether a file name encountered within the web access log is a dynamically generated file. If the present embodiment at step 304 determines that the file is dynamically generated, the present embodiment proceeds to step 306. However, if the present embodiment at step 304 determines that the file is not dynamically generated (i.e., static), the present embodiment proceeds to step 310. It should be understood that the present embodiment of flowchart 300 does not utilize dynamically generated files as they most often produce files with varying size which makes it hard to determine the actual size of the file. Instead, the present embodiment of flowchart 300 specifically utilizes static files of the web access log. Additionally, it is appreciated that the present embodiment at step 304 may determine whether a file is dynamically generated by using a wide variety of methods. For example, the present embodiment at step 304 may detect and filter dynamic files by parsing the suffix of the file. For example, the dynamic file suffixes may include ‘.cgi’ for CGI-scripts, ‘.pl’ for Perl, ‘.jsp’, and ‘.asp’. Furthermore, the present embodiment at step 304 may detect and filter dynamic files by checking for the suffix parameter marker ‘?’ because parameters are given to dynamically generated files or documents.

At step 306, the present embodiment determines whether the current file name is the last entry in the web access log of the web server. If the present embodiment determines that the current file is the last entry in the web access log of the web server at step 306, the present embodiment proceeds to exit flowchart 300. However, if the present embodiment determines that the current file is not the last entry in the web access log of the web server at step 306, the present embodiment proceeds to step 308. In step 308, the present embodiment proceeds to the next file name in the web access log of the web server. Once step 308 is completed, the present embodiment proceeds to step 304.

At step 310 of FIG. 3A, the present embodiment goes to the first transferred byte value corresponding to the current file. For example, if the present embodiment was dealing with the “index.html” file of web access log 400 (FIG. 4), at step 310 the present embodiment would go to the first transferred byte value of 10 kB adjacently located to the file name.

In step 312, the present embodiment determines whether the current transferred byte value (e.g., 10 kB) is equal to the previous transferred byte value. If the present embodiment determines that the current transferred byte value is not equal to the previous transferred byte value at step 312, the present embodiment proceeds to step 314. However, if the present embodiment determines that the current transferred byte value is equal to the previous transferred byte value at step 312, the present embodiment proceeds to step 318. It is understood that the previous transferred byte value may be stored within memory.

It should be appreciated that the present embodiment associated with steps 312-318 is trying to determine what the actual size is of the current file using the transferred byte values. This size determination is referred to as the “perceived size.” That is, the perceived size is set (or established) by the present embodiment at steps 312-318 whenever a file has the same transferred byte size two references in a row. The logic behind this being that if the present embodiment observes the same number of transferred bytes for a web file two times in a row, it is probably the real size of the web file. Conversely, there is a high probability that an aborted connection will not have the same amount of transferred bytes two times in a row. Furthermore, it is appreciated that the present embodiment associated with steps 312-318 may set the “perceived size” of a file whenever the file has the same transferred byte size “N” references in a row, where “N” is greater than or equal to 2.

For example, if the present embodiment associated with steps 312-318 was dealing with the “index.html” file of web access log 400 (FIG. 4), the present embodiment starts with the first transferred byte value and it observes that there are two references in a row of the same transferred byte size (e.g., 10 kB). Therefore, the present embodiment sets the perceived size for the “index.html” file equal to 10 kB.

It is appreciated that flowchart 300 of FIGS. 3A and 3B is well suited to be modified such the present embodiment enables the actual file sizes of the files contained within a web access log of a web server to be received from an external source (e.g., computer user, stored data, and the like) and subsequently stored for later use. In this manner, the present embodiment of flowchart 300 would not need to first determine the perceived size (e.g., actual size) of any file it encounters within the web access log. Instead, that information would be initially provided from an external source. It should be understood that this embodiment may become more complicated if any of the file sizes changed during the duration of the web access log analyzed.

At step 314 of FIG. 3A, the present embodiment determines whether the current transferred byte value is the last transferred byte value associated with the current file. If the present embodiment determines that the current transferred byte value is the last transferred byte value associated with the current file at step 314, the present embodiment proceeds to step 306. However, If the present embodiment determines that the current transferred byte value is not the last transferred byte value associated with the current file at step 314, the present embodiment proceeds to step 316. In step 316, the present embodiment proceeds to the next transferred byte value associated with the current file. Once step 316 is completed, the present embodiment proceeds to step 312. At step 318, the present embodiment sets the perceived size value equal to the current transferred byte value. It is understood that the perceived size may be set by storing its value within memory.

In step 320 of FIG. 3B, the present embodiment returns to the first transferred byte value of the current file in the web access log. For example, if the present embodiment was dealing with the “index.html” file of web access log 400 (FIG. 4), at step 320 the present embodiment would go to the first transferred byte value of 10 kB adjacently located to its file name. At step 322, the present embodiment determines whether the current transferred byte value is equal to the perceived size of the file (e.g., “index.html” file of web access log 400). If the present embodiment determines that the current transferred byte value (e.g., 6 kB) is not equal to the perceived size (e.g., 10 kB) at step 322, the present embodiment proceeds to step 328. However, if the present embodiment determines that the current transferred byte value (e.g., 10 kB) is equal to the perceived size (e.g., 10 kB) at step 322, the present embodiment proceeds to step 324.

In step 324, the present embodiment determines whether the current transferred byte value is the last transferred byte value of the current file. If the present embodiment determines that the current transferred byte value is the last transferred byte value of the current file at step 324, the present embodiment proceeds to step 306 of FIG. 3A. However, if the present embodiment determines that the current transferred byte value is not the last transferred byte value of the current file at step 324, the present embodiment proceeds to step 326 of FIG. 3B. At step 326, the present embodiment proceeds to the next transferred byte value of the current file. Once step 326 is completed, the present embodiment proceeds to step 322.

In step 328 of FIG. 3B, the present embodiment determines whether the current transferred byte value is greater that the perceived size of the current file. If the present embodiment at step 328 determines that the current transferred byte value (e.g., 6 kB) is not greater that the perceived size (e.g., 10 kB) of the current file (e.g., “index.html” file of web access log 400), the present embodiment proceeds to step 330. However, if the present embodiment at step 328 determines that the current transferred byte value (e.g., 17 kB) is greater that the perceived size (e.g., 12 kB) of the current file (e.g., the “story2.html” file of web access log 400), the present embodiment proceeds to step 340.

It should be understood that a modified document of the present embodiment produces a constant change to the number of transferred bytes of the current document (or file) and will thus change the perceived size to the new size of the document, while an aborted connection of the present embodiment still will produce a random number of transferred bytes that are less than the perceived size.

In step 340, the present embodiment increases a count that is associated with modified documents by the value of one indicating that a modified document has been discovered. It is understood that the modified documents count may be stored within memory. At step 342, the present embodiment sets the perceived size of the current file equal to the current transferred byte value. It is understood that the perceived size may be set by storing its value within memory. Once step 342 is completed, the present embodiment proceeds to step 324.

At step 330 of FIG. 3B, the present embodiment increases a count that is associated with aborted connections by the value of one indicating that an aborted connection may have been discovered. It is understood that the aborted connections count maybe stored within memory. In step 332, the present embodiment determines whether the current transferred byte value is the last transferred byte value of the current file (or document). If the present embodiment determines that the current transferred byte value is the last transferred byte value of the current file at step 332, the present embodiment proceeds to step 306 of FIG. 3A. However, if the present embodiment determines that the current transferred byte value is not the last transferred byte value of the current file at step 332, the present embodiment proceeds to step 334 of FIG. 3B.

At step 334, the present embodiment proceeds to the next transferred byte value of the current file in the web access log (e.g., 400). In step 336, the present embodiment determines whether the current transferred byte value is equal to the previous transferred byte value of the current file. If the present embodiment determines at step 336 that the current transferred byte value (e.g., 10 kB) is not equal to the previous transferred byte value (e.g., 6 kB) of the current file (e.g., “index.html” file of web access log 400), the present embodiment proceeds to the beginning of step 322. However, if the present embodiment determines at step 336 that the current transferred byte value (e.g., 15 kB) is equal to the previous transferred byte value (e.g., 15 kB) of the current file (e.g., the “design.html” file of web access log 400), the present embodiment proceeds to step 338.

At step 338 of FIG. 3B, the present embodiment decreases the count associated with aborted connections by the value of one because the present embodiment determined that a modification had occurred instead of an aborted connection. It should be pointed out that the present embodiment of flowchart 300 defines a connection as aborted if the following holds: there is a perceived size set (or established) for a file; a transferred byte size (e.g., 7 kB) of the file (e.g., the “story.html” file of web access log 400) in its log is less than the perceived size (e.g., 16 kB) of that file; the next transferred byte size (e.g., 4 kB) for this file is not the same size; and the file is not dynamically generated.

It should be understood that flowchart 300 is well suited to be modified such that its functionality is performed during a single reading of the data stored within a web access log. For example, for every file encountered within the web access log, its perceived size and its last transferred byte value may be stored. In this manner, the aborted connection count, modified document count, and file information are handled as they are encountered within the web access log.

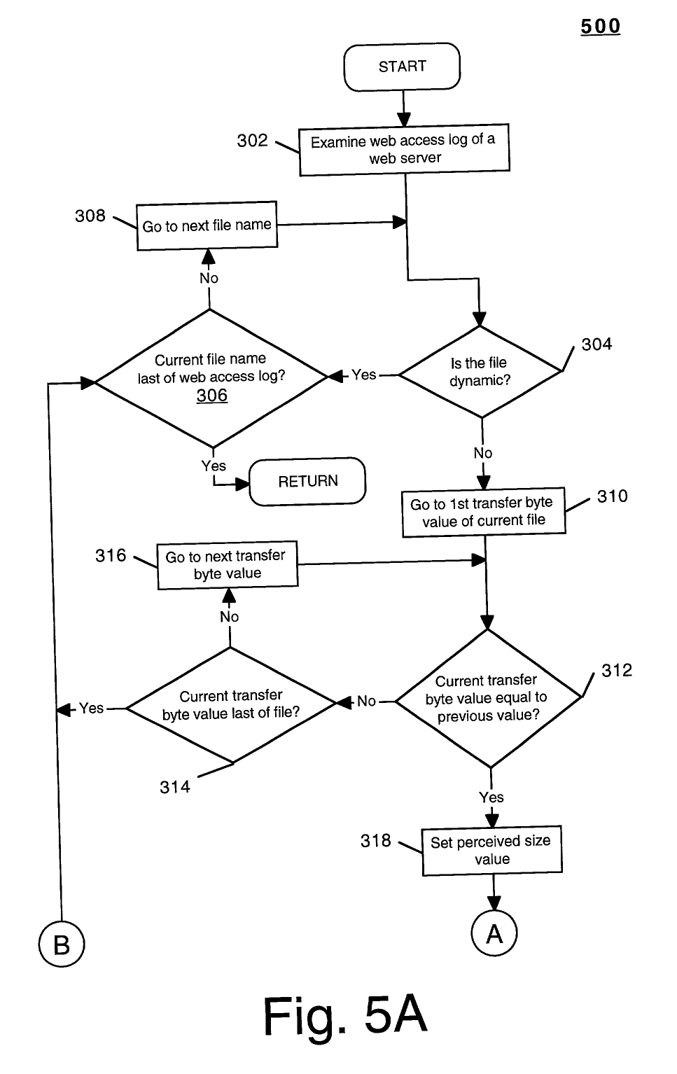

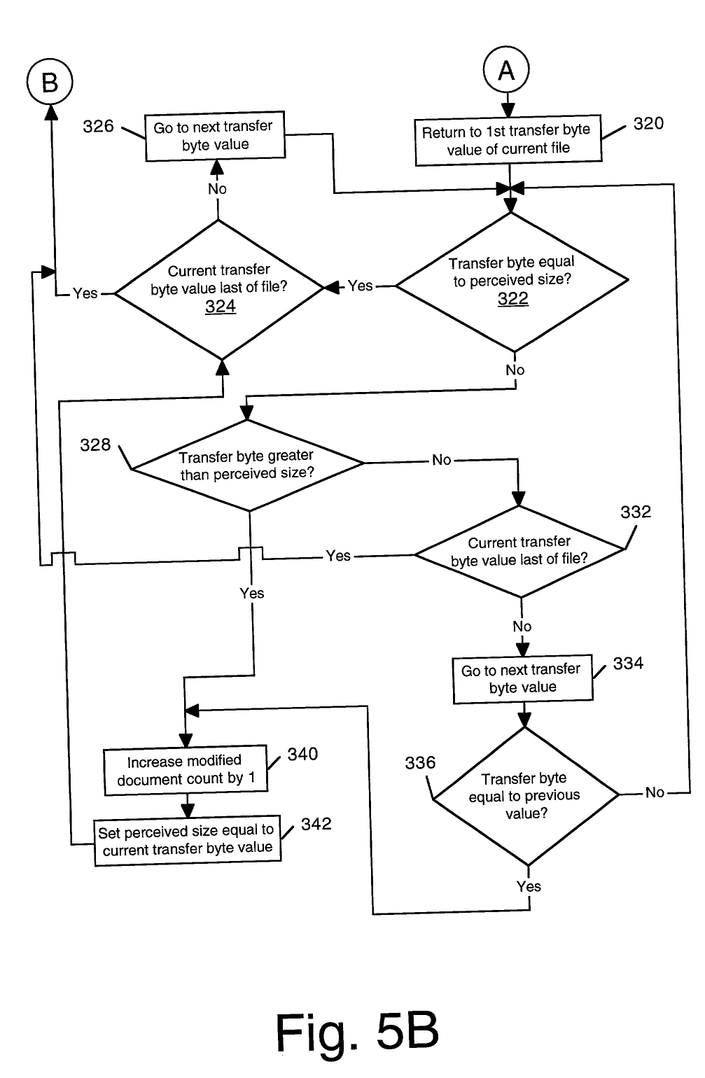

FIGS. 5A and 5B are a flowchart 500 of steps performed in accordance with one embodiment of the present invention for detecting modified documents within a web access log produced by a web server. Flowchart 500 includes processes of the present invention which, in one embodiment, are carried out by processors and electrical components under the control of computer readable and computer executable instructions. The computer readable and computer executable instructions reside, for example, in data storage features such as computer usable volatile memory 104 and/or computer usable non-volatile memory 106 of FIG. 1. However, the computer readable and computer executable instructions may reside in any type of computer readable medium. Although specific steps are disclosed in flowchart 500, such steps are exemplary. That is, the present invention is well suited to performing various other steps or variations of the steps recited in FIGS. 5A and 5B. Within the present embodiment, it should be appreciated that the steps of flowchart 500 may be performed by software or hardware or any combination of software and hardware.

It is understood that steps 302-328, 332-336, 340 and 342 of FIGS. 5A and 5B are similar to steps 302-328, 332-336, 340 and 342 of FIGS. 3A and 3B described above. However, if the present embodiment at step 328 determines that the current transferred byte value is not greater that the perceived size of the current file, the present embodiment proceeds to step 332. Furthermore, if the present embodiment determines at step 336 that the current transferred byte value is equal to the previous transferred byte value of the current file, the present embodiment proceeds to step 340. In this manner, the present embodiment keeps track of modified documents but does not keep tract of aborted connections. Therefore, flowchart 500 illustrates steps performed in accordance with one embodiment of the present invention for detecting modified documents within a web access log (e.g., 400) produced by a web server (e.g., 210A, 210B, or 210C).

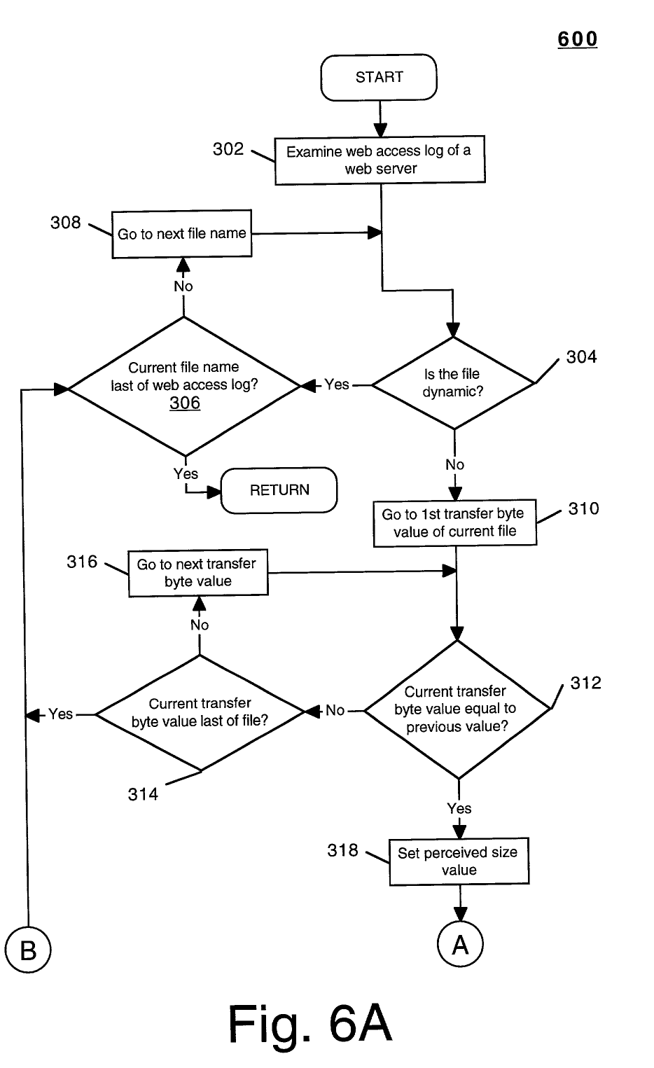

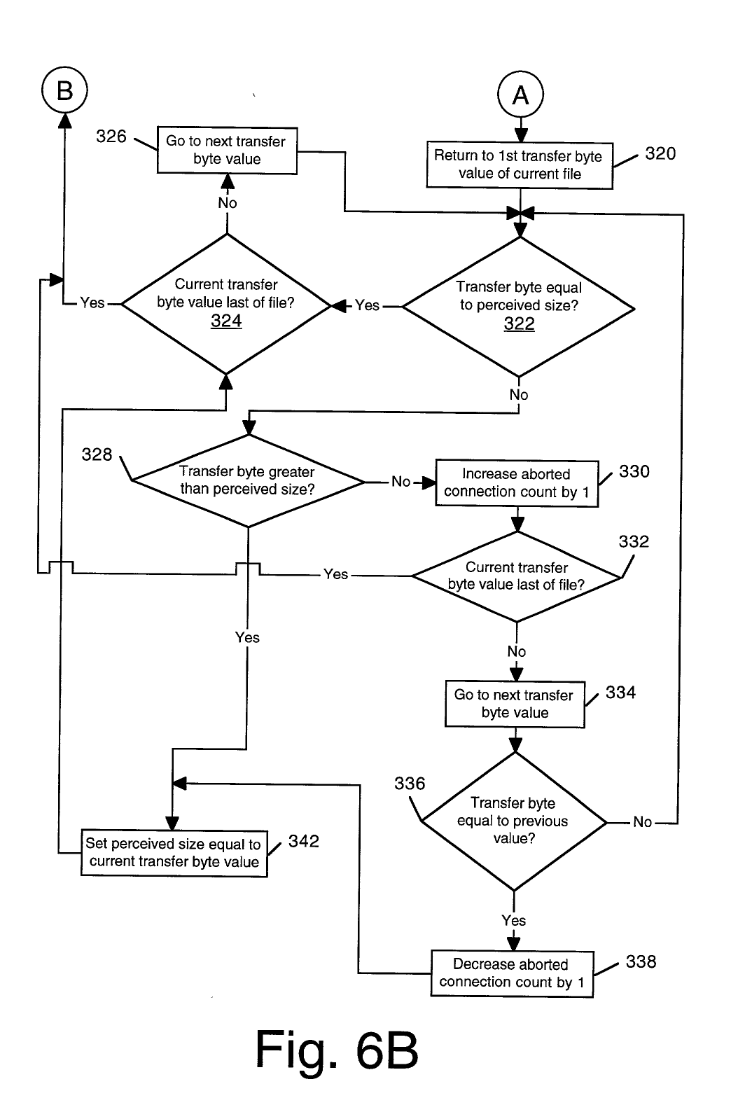

FIGS. 6A and 6B are a flowchart 600 of steps performed in accordance with one embodiment of the present invention for detecting aborted connections within a web access log produced by a web server. Flowchart 600 includes processes of the present invention which, in one embodiment, are carried out by processors and electrical components under the control of computer readable and computer executable instructions. The computer readable and computer executable instructions reside, for example, in data storage features such as computer usable volatile memory 104 and/or computer usable non-volatile memory 106 of FIG. 1. However, the computer readable and computer executable instructions may reside in any type of computer readable medium. Although specific steps are disclosed in flowchart 600, such steps are exemplary. That is, the present invention is well suited to performing various other steps or variations of the steps recited in FIGS. 6A and 6B. Within the present embodiment, it should be appreciated that the steps of flowchart 600 may be performed by software or hardware or any combination of software and hardware.

It is understood that steps 302-338, and 342 of FIGS. 6A and 6B are similar to steps 302-338, and 342 of FIGS. 3A and 3B described above. However, if the present embodiment at step 328 of FIG. 6B determines that the current transferred byte value is greater that the perceived size of the current file, the present embodiment proceeds to step 342. Furthermore, once step 338 of FIG. 6B is completed, the present embodiment proceeds to step 342. In this manner, the present embodiment keeps track of aborted connections but does not keep tract of modified documents. As such, flowchart 600 illustrates steps performed in accordance with one embodiment of the present invention for detecting aborted connections within a web access log (e.g., 400) produced by a web server (e.g., 210A, 210B, or 210C).

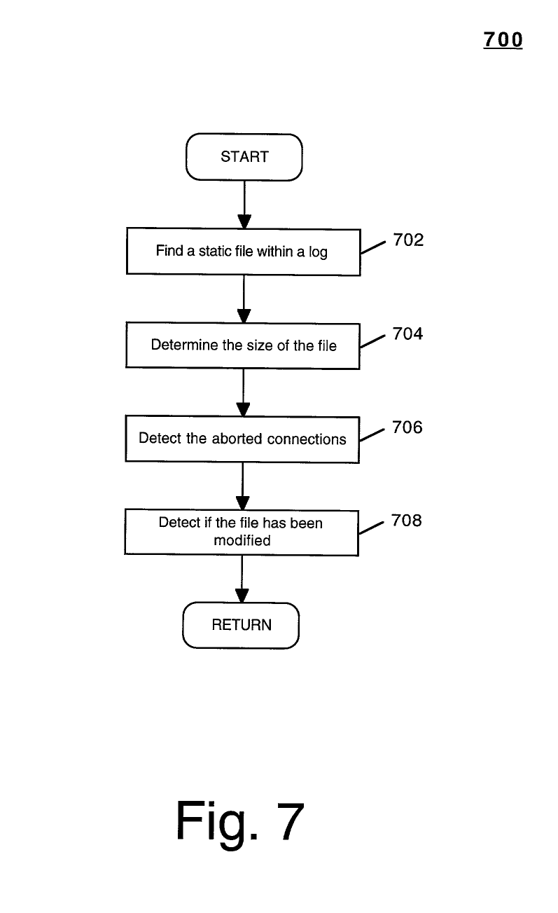

FIG. 7 is a flowchart 700 of steps performed in accordance with one embodiment of the present invention for detecting aborted connections and modified documents from web access logs produced by a web server. Flowchart 700 includes processes of the present invention which, in one embodiment, are carried out by processors and electrical components under the control of computer readable and computer executable instructions. The computer readable and computer executable instructions reside, for example, in data storage features such as computer usable volatile memory 104 and/or computer usable non-volatile memory 106 of FIG. 1. However, the computer readable and computer executable instructions may reside in any type of computer readable medium. Although specific steps are disclosed in flowchart 700, such steps are exemplary. That is, the present invention is well suited to performing various other steps or variations of the steps recited in FIG. 7. Within the present embodiment, it should be appreciated that the steps of flowchart 700 may be performed by software or hardware or any combination of software and hardware.

In step 702, the present embodiment finds a static file within a web access log (e.g., 400) associated with a web server (e.g., 210A, 210B or 210C). It is appreciated that the present embodiment may determine if a file is static in step 702 by utilizing any of the techniques described above. At step 704, the present embodiment determines the actual size of the static file. It is understood that the present embodiment may determine the actual size of the static file by utilizing any of the techniques described above.

At step 706 of FIG. 7, the present embodiment detects the aborted connections of the file by utilizing the size of the file and a transferred byte value of the web access log. It is understood that the transferred byte value corresponds to the amount of data transferred by the web server (e.g., 210A, 210B or 210C) in response to a request for the file by a client device (e.g., 202, 204 or 206). The present embodiment may detect the aborted connections of the file by utilizing any of the techniques described above. For example, the present embodiment may detect an aborted connection if the file size is larger than a first transferred byte value and the size of a subsequent second transferred byte value is not equal to the value of the first transferred byte value.

In step 708, the present embodiment detects that the file of the web access log has been modified by utilizing the size of the file and a transferred byte value of the web access log. The present embodiment may detect that the file of the web access log has been modified by utilizing any of the techniques described above. For example, if the present embodiment detects that the transferred byte value is greater than the size of the file, the present embodiment may conclude that the file has been modified. Additionally, if the present embodiment detects that a first transferred byte value is less than the size of the file and a subsequent second transferred byte value is equal to the first transferred byte value, the present embodiment may conclude that the file has been modified.

It should be appreciated that step 708 of FIG. 7 does not have to be performed after step 706 as shown. That is, the order that steps 706 and 708 are performed may be modified in accordance with the present embodiment. Furthermore, it should be understood that the functionality of flowchart 700 may be performed for every file encountered within the web access log (e.g., 400) of the web server (e.g., 210A, 210B or 210C).

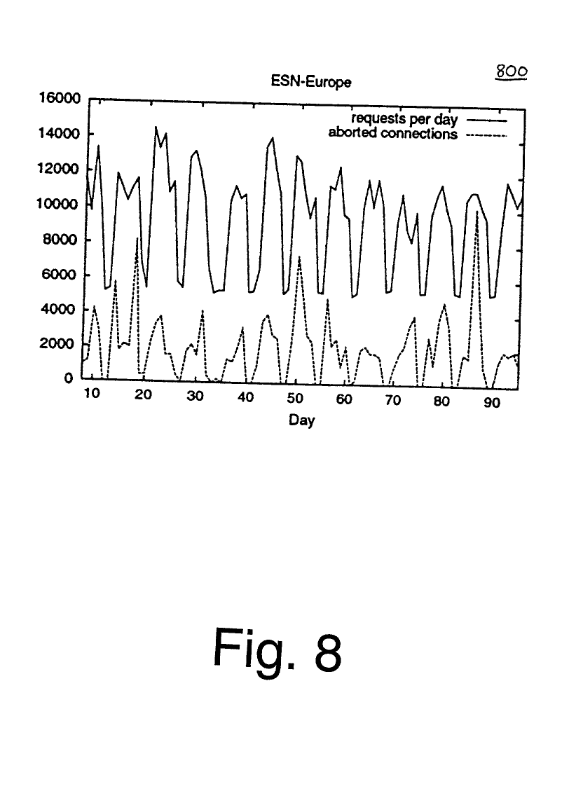

FIG. 8 is a graph 800 illustrating the number of aborted connections and requests per day that the ESN-Europe web site experienced over an established time period. Graph 800 may be produced utilizing information gathered by an embodiment of the present invention. For example, flowchart 600 of FIGS. 6A and 6B may have been utilized to determine the amount of aborted connections that occurred each day from web access logs produced by one or more web servers of the ESN-Europe web site. It is important to note that graph 800 shows that as the requests that the ESN-Europe web site received per day increased, the aborted connections also increased. So when the demand was high, the web server(s) of the ESN-Europe web site are not able to respond quickly to the requests and the client users are aborting their connections. Conversely, when the demand is low, the web server(s) of the ESN-Europe web site are able to handle the requests and so the aborted connections are also low. As such, a conclusion can be made that the server(s) of the ESN-Europe web site are clearly to blame for the aborted connections. It is important to note that the number of aborted connections in graph 800 is scaled up 200 times for easier reference.

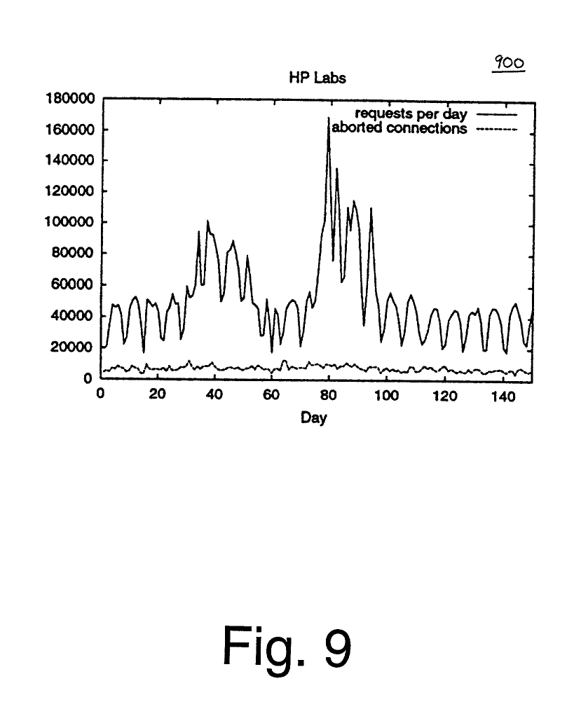

FIG. 9 is a graph 900 illustrating the number of aborted connections and requests per day that the Hewlett Packard (HP) Labs web site experienced over an established time period. Graph 900 may also be produced utilizing information gathered by an embodiment of the present invention. For example, flowchart 300 of FIGS. 3A and 3B may have been utilized to determine the amount of aborted connections that occurred each day from web access logs produced by one or more web servers of the HP Labs web site. It is important to note that graph 900 shows that there is nearly no correlation between the number of requests per day that the HP Labs web site received and its number of aborted connections. Specifically, there is a constant number (more or less) of aborted connections over the days observed. Therefore, the conclusion can be made that the web server(s) of the HP Labs web site are not to blame for the aborted connections. It is important to note that the number of aborted connections in graph 900 is scaled up 100 times for easier reference.

Accordingly, the present invention provides a method and system for detecting aborted connections of a web server that is able to function across different web server platforms and does not involve modify web server application code. Furthermore, the present invention also provides a method and system which satisfies the above accomplishments and is not burdensome to implement. Additionally, the present invention also provides a method and system which satisfies the above accomplishments and does not adversely affect web server performance and is cost efficient.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method for detecting an aborted connection from a log of a server, said method comprising the steps of:
(a) finding a file within said log that is static; and
(b) detecting said aborted connection utilizing the size of said file and a first data value of a plurality of data values of said log of said server, wherein said plurality of data values correspond to data transferred by said server in response to requests for said file.

2. The method as described in claim 1 wherein said server comprises a web server.

3. The method as described in claim 1 wherein said file comprises web content.

4. The method as described in claim 1 wherein said step (a) further comprises the step of:
finding said file within said log that is static by parsing a suffix of the name of said file.

5. The method as described in claim 1 wherein said step (a) further comprises the step of:
finding said file within said log that is static by identifying that a parameter is associated with the name of said file.

6. The method as described in claim 1 wherein said step (b) further comprises the step of:
detecting said aborted connection utilizing the size of said file and said first data value, wherein the size of said first data value is less than the size of said file.

7. The method as described in claim 1 wherein said step (b) further comprises the step of:
detecting said aborted connection utilizing the size of said file and said first data value, wherein the size of said first data value is less than the size of said file and the size of a subsequent second data value is not equal to the size of said first data value.

8. The method as described in claim 1 further comprising the step of:
(c) detecting said file has been modified utilizing the size of said file and a second data value of said plurality of data values.

9. The method as described in claim 8 wherein said step (c) further comprises:
detecting said file has been modified utilizing the size of said file and said second data value, wherein the size of said second data value is greater than the size of said file.

10. The method as described in claim 8 wherein said step (c) further comprises:
detecting said file has been modified utilizing the size of said file and said second data value, wherein the size of said second data value is less than the size of said file and the size of a subsequent third data value is equal to the size of said second data value.

11. A method for detecting an aborted connection from a log of a server, said method comprising the steps of:
(a) finding a file within said log that is static;
(b) determining the size of said file by utilizing a plurality of data values of said log that correspond to data transferred by said server in response to requests for said file; and
(c) detecting said aborted connection utilizing the size of said file and a first data value of said plurality of data values of said log of said server.

12. The method as described in claim 11 wherein said server comprises a web server.

13. The method as described in claim 11 wherein said file comprises web content.

14. The method as described in claim 11 wherein said step (a) further comprises the step of:
finding said file within said log that is static by parsing a suffix of the name of said file.

15. The method as described in claim 11 wherein said step (a) further comprises the step of:
finding said file within said log that is static by determining that a parameter is associated with the name of said file.

16. The method as described in claim 11 wherein said step (b) further comprises the step of:
determining the size of said file by utilizing a first data value and a second data value of said plurality of data values, wherein the size of said first data value is equal to the size of the second data value.

17. The method as described in claim 11 wherein said step (c) further comprises the step of:
detecting said aborted connection utilizing the size of said file and said first data value of said plurality of data values, wherein the size of said first data value is less than the size of said file.

18. The method as described in claim 11 further comprising the step of:
(d) detecting said file has been modified utilizing the size of said file and the size of a second data value of said plurality of data values.

19. The method as described in claim 18 wherein said step (d) further comprises:
detecting said file has been modified utilizing the size of said file and the size of said second data value, wherein the size of said second data value is greater than the size of said file.

20. The method as described in claim 18 wherein said step (d) further comprises:
detecting said file has been modified utilizing the size of said file and the size of said second data value, wherein the size of said second data value is less than the size of said file and the size of a subsequent third data value of said plurality of data values is equal to the size of said second data value.

21. A computer readable medium having computer readable code embodied therein for causing a computer to perform particular steps of:
(a) finding a file that is static within a log of a server; and
(b) detecting said aborted connection utilizing the size of said file and a first data value of a plurality of data values of said log of said server, wherein said plurality of data values correspond to data transferred by said server in response to requests for said file.

22. The computer readable medium as described in claim 21 wherein said server comprises a web server.

23. The computer readable medium as described in claim 21 wherein said file comprises web content.

24. The computer readable medium as described in claim 21 wherein said step (a) further comprises the step of:
finding said file that is static within said log by parsing a suffix of the name of said file.

25. The computer readable medium as described in claim 21 wherein said step (a) further comprises the step of:
finding said file that is static within said log by identifying that a parameter is associated with the name of said file.

26. The computer readable medium as described in claim 21 wherein said step (b) further comprises the step of:
detecting said aborted connection utilizing the size of said file and said first data value, wherein the size of said first data value is less than the size of said file.

27. The computer readable medium as described in claim 21 wherein said step (b) further comprises the step of:
detecting said aborted connection utilizing the size of said file and said first data value, wherein the size of said first data value is less than the size of said file and the size of a subsequent second data value is not equal to the size of said first data value.

28. The computer readable medium as described in claim 21 further comprising the step of:
(c) detecting said file has been modified utilizing the size of said file and a second data value of said log of said server.

29. The computer readable medium as described in claim 28 wherein said step (c) further comprises:
detecting said file has been modified utilizing the size of said file and a second data value, wherein the size of said second data value is greater than the size of said file.

30. The computer readable medium as described in claim 28 wherein said step (c) further comprises:
detecting said file has been modified utilizing the size of said file and a second data value, wherein the size of said second data value is less than the size of said file and the size of a subsequent third data value is equal to the size of said second data value.
